(19) United States
(12) Patent Application Publication
(10) Pub. No.: US 2021/0383308 A1
(43) Pub. Date: Dec. 9, 2021

(54) MACHINE LEARNING SYSTEMS FOR REMOTE ROLE EVALUATION AND METHODS FOR USING SAME

(71) Applicant: Job Market Maker, LLC, Charleston, SC (US)

(72) Inventors: Joseph W. Hanna, Charleston, SC (US); David Trachtenberg, Charleston, SC (US); Christina R. Petrosso, Folly Beach, SC (US)

(21) Appl. No.: 17/341,093

(22) Filed: Jun. 7, 2021

Related U.S. Application Data
(60) Provisional application No. 63/035,372, filed on Jun. 5, 2020.

(51) Int. Cl. G06Q 10/06; G06N 20/00

(52) U.S. Cl. CPC G06Q 10/063112; G06N 20/00; G06Q 10/06398

(57) ABSTRACT

A machine learning system can include a data store and at least one computing device in communication with the data store. The computing device can receive data describing at least one aspect of a position for an entity. The computing device can generate metadata for the position based on the data describing the at least one aspect of the position, the metadata comprising skills and tasks associated with the position. The computing device can identify task locations for the entity and determine a distribution of capacity across the task locations based on entity data describing individuals associated with the entity. The computing device can generate physical proximity scores for each of the skills and tasks based on the metadata for the position, the distribution of capacity, and the task locations. The computing device can generate a remote work score for the position based on the physical proximity scores.

### CROSS REFERENCE TO RELATED APPLICATIONS

This application claims the benefit of and priority to U.S. Application No. 63/035,372, filed Jun. 5, 2020, titled “REMOTE ROLE RECOMMENDATION ENGINE,” the disclosure of which is incorporated herein by reference in its entirety.

### TECHNICAL FIELD

The present systems and processes relate generally to machine learning-based analysis and classification of remote tasks.

### BACKGROUND

Machine learning generally refers to an application of artificial intelligence (AI) that provides systems the ability to automatically learn and improve from experience without being explicitly programmed. Machine learning typically focuses on the development of computer programs that can access data and use it to learn for themselves.

Previous approaches to estimating collaborative effort of tasks and positions have typically relied upon heuristics. However, heuristics-based approaches may fail to consider or accurately weight all factors that may influence a position's collaborative quality. Accordingly, there exists an unmet need for systems and methods that can more accurately predict the potential of a task to be performed remotely.

### BRIEF SUMMARY OF THE DISCLOSURE

Briefly described, and according to one embodiment, aspects of the present disclosure generally relate to apparatuses, systems, and methods for determining if a particular job position can be performed remotely.

In particular embodiments, the disclosed system performs actions on input data to determine if a particular job can be performed remotely. In various embodiments, a job is considered remote if an individual can perform the tasks, skills, and requirements of a particular job position without having to perform them at a specific office or location. Conversely, a job position may be considered on-site if an individual must perform the tasks, skills, and requirements of a particular job position in a specific office or location. In at least one embodiment, the input data includes any form of transmissible information or data pertaining to a particular job position. For example, the input data may include, but is not limited to, textual job description, recorded audio job descriptions, video recorded job descriptions, local or private databases, licensed databases, public databases, and recorded interviews. In particular embodiment, the disclosed system processes the input data using machine learning techniques and categorizes the entity data into a metadata dataset. The metadata is attached to its corresponding job position and stored for further processing.

In various embodiments, the disclosed system performs a variety of analytical operations on the job position, its corresponding metadata, and any other source of data pertaining to a job position. Using machine learning techniques and natural language processing tools, the disclosed system may determine the office locations of a particular company, the capacity of talent distributed across a company's offices, defined metric scores for different aspects of the job position, a work score, and a work designation. The work score may determine quantitatively the likelihood for a particular job position to be performed remotely using various defined metric scores and any dataset pertaining to a job position. The work designation may refer to a determination by the system, based on the work score, if whether a job can be performed on-site, remote, or any degree between the two aforementioned states. The disclosed system may also determine what particular tasks and skills have a large or small influence on whether a job position will be on-site or remote. In one or more embodiments, the disclosed system stores the aggregated data, analysis results, and/or other information pertaining to a job position for further use.

According to a first aspect, a machine learning system, comprising: A) a data store comprising entity data for an entity, the entity data comprising data describing a plurality of individuals associated with the entity; B) at least one computing device in communication with the data store, the at least one computing device being configured to: 1) receive data describing at least one aspect of a position for the entity; 2) generate metadata for the position based on the data describing the at least one aspect of the position, the metadata comprising a plurality of skills and tasks associated with the position; 3) identify a plurality of task locations for the entity; 4) determine a distribution of capacity across the plurality of task locations based on the entity data; 5) generate a plurality of physical proximity scores for each of the plurality of skills and tasks based on the metadata for the position, the distribution of capacity, and the plurality of task locations; and 6) generate a remote work score for the position based on the plurality of physical proximity scores.

According to a further aspect, the machine learning system of the first aspect or any other aspect, wherein generating the plurality of physical proximity scores is further based on at least one data set comprising a plurality of known proximity scores corresponding to a plurality of known skills and tasks.

According to a further aspect, the machine learning system of the first aspect or any other aspect, wherein the at least one computing device is further configured to: A) determine the remote work score is below a predefined remote work threshold; and B) identify at least one particular physical location for the position based on the plurality of physical proximity scores.

According to a further aspect, the machine learning system of the first aspect or any other aspect, wherein the metadata further comprising at least one of: a location of the position, an identifier of the entity, and a position identifier.

According to a further aspect, the machine learning system of the first aspect or any other aspect, wherein the at least one computing device is further configured to generate the metadata by parsing the data describing the at least one aspect of the position by applying a deep learning and natural language processing algorithm to the at least one aspect of the position.

According to a further aspect, the machine learning system of the first aspect or any other aspect, wherein the at least one computing device is further configured to periodically capture and index publically accessible data relating to positions and store the data in the data store for use in generating the metadata for the position.

According to a second aspect, a machine learning method, comprising: A) receiving, via at least one computing device, data describing at least one aspect of a position for an entity; B) receiving, via the at least one computing device, entity data comprising respective individual data for each of a plurality of individuals at the entity; C) generating, via the at least one computing device, metadata for the position based on the data describing the at least one aspect of the position, the metadata comprising a plurality of skills and tasks associated with the position; D) identifying, via the at least one computing device, a plurality of task locations for the entity; E) determining, via the at least one computing device, a distribution of capacity across the plurality of task locations based on the entity data; F) generating, via the at least one computing device, a plurality of physical proximity scores for each of the plurality of skills and tasks based on the metadata for the position, the distribution of capacity, and the plurality of task locations; and G) generating, via the at least one computing device, a remote work score for the position based on the plurality of physical proximity scores.

According to a further aspect, the machine learning method of the second aspect or any other aspect, wherein the metadata is generated further based on the entity data.

According to a further aspect, the machine learning method of the second aspect or any other aspect, further comprising generating a remote working designation for the position based on the remote work score falling into a particular bin of a plurality of remote work score bins.

According to a further aspect, the machine learning method of the second aspect or any other aspect, further comprising: A) generating, via the at least one computing device, a training data set for the entity using the entity data, the training data set comprising first position data describing known on-premise positions and second portion data describing known remote positions; and B) training, via the at least one computing device, a machine learning model using the training data set, wherein the plurality of physical proximity scores are generated via the machine learning model.

According to a further aspect, the machine learning method of the second aspect or any other aspect, wherein the machine learning model is configured to identify remote working criteria predictive for on-premise or remote positions when executed by the at least one computing device, wherein the method further comprises: A) generating, via the at least one computing device, a second machine learning model based on the machine learning model, the second machine learning model being configured to predict a proximate importance for each the plurality of skills and tasks using the remote working criteria.

According to a further aspect, the machine learning method of the second aspect or any other aspect, further comprising: A) receiving, via the at least one computing device, a remote work result for the position subsequent to fulfilment of the position; and B) retraining, via the at least one computing device, the machine learning model based on the remote work result.

According to a third aspect, a non-transitory computer-readable medium embodying a program that, when executed by at least one computing device, causes the at least one computing device to: A) receive data describing at least one aspect of a position for an entity; B) generate metadata for the position based on the data describing the at least one aspect of the position, the metadata comprising a plurality of skills and tasks associated with the position; C) identify a plurality of task locations for the entity; D) determine a distribution of capacity across the plurality of task locations based on data comprising respective individual data for each of a plurality of individuals at the entity; E) generate a plurality of physical proximity scores for each of the plurality of skills and tasks based on the metadata for the position, the distribution of capacity, and F) the plurality of task locations; and generate a remote work score for the position based on the plurality of physical proximity scores.

According to a further aspect, the non-transitory computer-readable medium embodying a program of the third aspect or any other aspect, wherein the program further causes the at least one computing device to generate the remote work score by combining the plurality of physical proximity scores for each of the plurality of skills and tasks according to a predetermined weighting.

According to a further aspect, the non-transitory computer-readable medium embodying a program of the third aspect or any other aspect, wherein the program further causes the at least one computing device to compute the predetermined weighting for combining the plurality of physical proximity scores based on the metadata.

According to a further aspect, the non-transitory computer-readable medium embodying a program of the third aspect or any other aspect, wherein the program further causes the at least one computing device to generate the remote work score via a trained machine learning model.

According to a further aspect, the non-transitory computer-readable medium embodying a program of the third aspect or any other aspect, wherein the program further causes the at least one computing device to generate the trained machine learning model by: A) generating an initial machine learning model; B) training, with a training dataset, the initial machine learning model to generate one or more experimental remote work predictions, wherein the training dataset comprises historical entity data associated with the position and one or more known remote work outcomes associated with the historical entity data; C) determining an error of the initial machine learning model by comparing the one or more experimental remote work predictions to the one or more known remote work outcomes; and D) generating a secondary machine learning model by adjusting the initial machine learning model based on the error, wherein the trained machine learning model is the secondary machine learning model.

According to a further aspect, the non-transitory computer-readable medium embodying a program of the third aspect or any other aspect, wherein: A) the initial machine learning model comprises a plurality of parameters and a first set of weight values that are applied to each of the plurality of parameters, wherein: 1) the plurality of parameters are based on the plurality of physical proximity scores; and 2) the first set of weight values determines a level of contribution of each of the plurality of parameters to the remote work score; and B) the program further causes the at least one computing device to generate the secondary machine learning model by: 1) determining at least one of the plurality of parameters that most contributed to the error; 2) adjusting one or more weight values of the first set of weight values that are associated with the at least one the plurality of parameters to generate a secondary set of weight values; and 3) generating the secondary machine learning model based on the plurality of parameters and the secondary set of weight values.

According to a further aspect, the non-transitory computer-readable medium embodying a program of the third aspect or any other aspect, wherein the program further causes the at least one computing device to generate a report comprising the remote work score.

According to a further aspect, the non-transitory computer-readable medium embodying a program of the third aspect or any other aspect, wherein: A) the program further causes the at least one computing device to determine at least one physical proximity score from the plurality of physical proximity scores that most positively contributed to the remote work score; and B) the report further comprises the at least one physical proximity score that most positively contributed to the remote work score.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 shows an exemplary remote role recommendation system, according to one embodiment of the present disclosure;

FIG. 2 shows an exemplary remote work recommendation process, according to one embodiment of the present disclosure; and

FIG. 3 shows an exemplary machine learning process, according to one embodiment of the present disclosure.

### DETAILED DESCRIPTION

In particular embodiments, the disclosed system determines whether a particular job position can be performed remotely. In various embodiments, the disclosed system uses a variety of machine learning techniques, natural language processing tools, and/or any other form of computational algorithms to determine how likely a particular job can be performed remotely. In one or more embodiments, a user inputs a job description and/or any other form of transmissible information regarding a job position to the disclosed system. The transmissible information may include, but is not limited to, textual job descriptions, interview recordings, internal job postings, external job postings, video recordings, internal or private databases, public databases, licensed databases, and/or any other information pertaining to a particular job position. The disclosed system may employ the natural language processing techniques and/or general processing tools to determine the content of the transmissible information. In at least one embodiment, the disclosed system organizes the transmissible information, also referred to herein as entity data, into datasets depending of the categorization of the data. For example, the name of a particular task may be stored into a position dataset, while a person's name can be stored in a user dataset. Once categorized, the disclosed system may organize the datasets into one large dataset, also referred to herein as metadata, and is attached to its corresponding job position.

In various embodiments, once the disclosed system has organized and extracted the content of the transmissible information, the disclosed system can analyze the metadata and other data sources herein. In particular embodiments, the disclosed system analyzes the metadata, public and private data sources, licensed data sources, and/or any other location that contains pertinent data and information. In one or more embodiments, the disclosed system uses machine learning techniques and natural language processing tools to identify task locations and determine capacity distributions. By determining task locations, the disclosed system may determine the office locations of a particular company. After identifying the task locations of a particular company, the disclosed system may determine the talent that is distributed amongst those offices or remote locations. In at least one embodiments, the disclosed system saves the task locations and capacity distribution information in a dataset and analyzes this data to determine particular defined metric scores using machine learning techniques or computational algorithms. In various embodiments, the defined metrics scores quantitatively value particular aspects of a particular job position. Some examples of defined metric scores include, but are not limited to, location scores, engagement scores, and capacity scores. In some embodiments, the defined metric scores are stored into a dataset for further processing.

In one or more embodiments, the disclosed system analyzes the metadata, defined metric scores, and/or any other information pertinent to a particular job positon to determine a work score using machine learning techniques or computational algorithms. In particular embodiments, the work score quantitatively measures how likely a particular job position can be performed remotely. In various embodiments, the disclosed system relates the work score to a scale to determine a remote work designation, where a remote work designation predicts whether a job position can be performed remote, on-site, or any degree between the two aforementioned states. In various embodiments, other terms or scales are used by the remote work designation to categorize a particular work score.

After producing a remote work designation, the disclosed system may store all information and data used to create the particular remote work designation output. In various embodiments, the disclosed system outputs the results of the remote work designation, or any other information gathered during the production of the remote work designation to a desired computational device. The computational device receiving any set of information from the disclosed system may include user interfaces to display the information to a user. The disclosed system may also output the most important and least important tasks and skills that were used to determine the remote work designation.

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to machine learning-based solutions for evaluating the capability of fulfilling a position, task, or responsibility remotely.

### Exemplary Embodiments

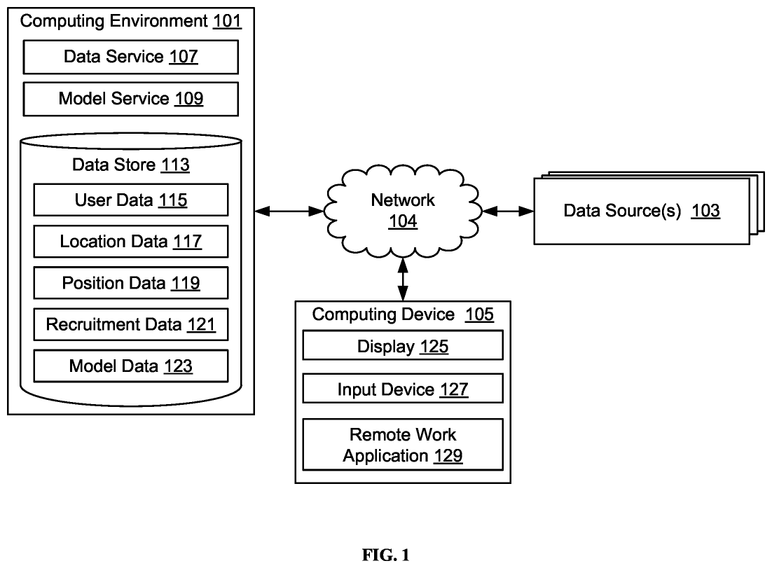

Referring now to the figures, for the purposes of example and explanation of the fundamental processes and components of the disclosed systems and processes, reference is made to FIG. 1, which illustrates an exemplary prediction system 100. As will be understood and appreciated, the exemplary, prediction system 100 shown in FIG. 1 represents merely one approach or embodiment of the present system, and other aspects are used according to various embodiments of the present system.

In various embodiments, the prediction system 100 includes a prediction system configured to perform one or more processes for predictive targeting and engagement. The prediction system 100 may include, but is not limited to, a computing environment 101, one or more data sources 103, and one or more computing devices 105 over a network 104. The network 104 includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks.

According to one embodiment, the computing environment 101 includes, but is not limited to, a data service 107, a model service 109, and a data store 113. The elements of the computing environment 101 can be provided via a plurality of computing devices that may be arranged, for example, in one or more server banks or computer banks or other arrangements. Such computing devices can be located in a single installation or may be distributed among many different geographical locations. For example, the computing environment 101 can include a plurality of computing devices that together may include a hosted computing resource, a grid computing resource, and/or any other distributed computing arrangement. In some cases, the computing environment 101 can correspond to an elastic computing resource where the allotted capacity of processing, network, storage, or other computing-related resources may vary over time.

The data service 107 can be configured to request, retrieve, and/or process data from data sources 103. In one example, the data service 107 is configured to automatically and periodically (e.g., every 6 hours, 3 days, 2 weeks, etc.) collect job descriptions from a database of a recruitment agency or from a company website. In another example, the data service 107 is configured to request and receive skill and task information for one or more position from a career accreditation or certification website. In another example, the data service 107 is configured to receive location data that defines one or more qualities of a particular location, such as average income, housing availability, cost of living, population density, traffic patterns, public transit availability, universities, and talent density for one or more disciplines (e.g., software development, data science, etc.). In another example, the data service 107 is configured to receive proprietary market analyses from a privileged database.

The data service 107 can be configured to monitor for changes to various information at a data source 103. In one example, the data service 107 scrapes public websites to monitor for changes to location data of one or more locations. In another example, the data service 107 monitors for changes to job postings for a plurality of company accounts on a social networking recruitment website. In another example the data service 107 monitors for changes to a plurality of office profiles at a company database. In this example, the data service 107 detects that an estimated onboarding time of a particular office has changed from “2-3 weeks” to “1-2 months.” Continuing this example, in response to the determination, the data service 107 automatically collects the new location information, which may be stored in the data store 113.

In various embodiments, the data service 107 is configured to perform analyses of various data, and the data service 107 may coordinate with the model service 109 to perform one or more analyses (e.g., the data service 107 may call the model service 109 to execute various functions). In one example, the data service 107 commands the model service 109 to analyze a job description input including a plurality of skills and tasks, analyze historical job data from one or more databases, generate associations between the plurality of skills and tasks and one or more historical job positions, and generate associations between one or more historical skills or tasks and the job description.

The data service 107 can be configured to determine likely categories or bins for various data. The data service 107 can utilize classifications and bins to determine additional relevant information that may limit or otherwise influence geographic options for fulfilling a position. As an example, the data service 107 determines that the skills and tasks “building APIs, Java, Scala, C#” fits into a bin for “software development, backend.” In some embodiments, the data service 107 can use natural language processing (NLP) to assign bins to various skills and tasks. As an example, the data service 107 can convert each of the skills and tasks into multi-dimensional vectors, and identify a closest bin based on a distance to multi-dimensional vector or areas corresponding to each bin. In some embodiments, the vectors for various bins can be tuned as new skills and tasks are assigned to the bin. Further, based on the classification, the data service 107 can match the skills and tasks to historical job positions, and the data service 107 can determine additional position metadata based on the historical job positions, such as backend web development certifications, alma maters, tenure, and performance ratings. In another example, the data service 107 analyzes a job description for a project manager position and determines that a salary range of “$140,000-170,000” fits into a middle level-bin for the salary range being a “3 of 5 level.” In the same example, based on the classification, the data service 107 matches the job description to historical position data for project manager positions at a plurality of locations. Continuing the example, based on the historical position data, the data service 107 generates additional metadata for use in generating remote role recommendations, such as historical salary trends, estimated requirements for remote worker expenses, housing costs, transportation costs, and proximity to talent pools (e.g., universities, competitors, etc.).

In some embodiments, the data service 107 is configured to perform one or more actions, for example, in response to input received from a computing device 105. In one example, in response to a request for information on a particular job position, the data service 107 analyzes historical location data 117 and position data 119 and determines position titles, types, and tasks that were associated with the particular job position. In this example, the position titles, types, and tasks are displayed at a computing device 105 from which the request is received. In another example, the data service 107 identifies and transmits job position criteria demonstrated by one or more filled or unfilled job positions. In this example, the job position criteria can provide a user with an overview of exemplary job position qualities and other information that may be relevant to staffing processes for other employment sources, organizations, or positions (e.g., which may be similar or dissimilar to those with which the job position criteria is associated). In some example, the location criteria can include a weighted scoring system, and the data service 107 can analyze the location criteria by performing iterative regression analysis on the historical location data 117 and position data 119 to identify correlations in the data. In some embodiments, the data service 107 can use machine learning to identify optimal location criterial based on the historical location data 117 and position data 119. In another example, the data service 107 receives a request to evaluate a particular location for a particular position title (e.g., also referred to as a position identifier), type, or task. In this example, the data service 107 retrieves location data 117 (and/or other data) with which the particular location is associated and compares the location data 117 to historical data with which the position titles, task, or type (or similar positions) are associated. Continuing the example, based on the comparison, the data service 107 determines one or more deficiencies in criteria of the particular location that, when filled, may increase the suitability of the particular location for filling the position title, type, or task. In the same example, the one or more deficiencies are displayed on the computing device 105.

The model service 109 can be configured to perform various data analysis and modeling processes. The model service 109 can generate, train, and execute neural networks, gradient boosting algorithms, mutual information classifiers, random forest classification, and other machine learning and related algorithms. In at least one embodiment, outputs generated by the model service 109 may be binary (e.g., exemplary predictions being “job position A is a suitable remote work position” and “job position B is not a suitable remote work position”), or may be correlated to a scale (e.g., exemplary predictions being “job positon A is more likely suited as a remote work position” and “job position B is less likely suited as a remote work position”). In one or more embodiments, outputs may be formatted as classifications determined and assigned based on comparisons between prediction scores (generated by machine learning models) and prediction thresholds that may be predefined and/or generated according to one or more machine learning models.

In one example, the model service 109 generates and trains machine learning models for recommending if a particular task or job position can be performed remotely. In this example, the machine learning models can generate metric scores for various input data types (e.g., work scores, talent scores, collaboration scores, remote work scores, location scores, etc.), and the machine learning models can generate a numerical score or a classification regarding whether a job can be performed remotely or not. In another example, the model service 109 generates and trains machine learning models for classifying job descriptions (e.g., or information derived therefrom) into one or more categories or bins.

In various embodiments, the model service 109 determines the degree of collaboration a job position may entail. In one or more embodiments, the model service 109 generates a recommendation for whether a position should be remote based or in person. The model service 109 can evaluate collaboration and remote work according to one or more embodiments described in U.S. Patent Application No. 63,035,379, filed Jun. 5, 2020, titled “COLLABORATION INDEX” or U.S. Patent Application No. 63,035,365, filed Jun. 5, 2020, titled “LOCATION RECOMMENDATION ENGINE,” the disclosures of which are incorporated herein by reference in their entireties.

The model service 109 or data service 107 can be configured to perform various data processing and normalization techniques to generate input data for machine learning and other analytical processes. Non-limiting examples of data processing techniques include, but are not limited to, entity resolution, imputation, and missing, outlier, or null value removal. In one example, the model service 109 performs entity resolution on location data for a plurality of locations to standardize terms such as position titles, company names, and task or skill descriptors. Entity resolution may include disambiguating manifestations of real-world entities in various records or mentions by linking and grouping. In one embodiment, a dataset of entity data may include a plurality of titles for a single position, and the model service 109 can perform entity resolution to associate the titles with the position. In one or more embodiments, the model service 109 may perform entity resolution to identify data items that refer to the same employer, but may use variations of the employer's title or different entity names owned by or controlled by the employer. In an exemplary scenario, a dataset may include references to an employer, Facebook, Inc.; however, various dataset entries may refer to Facebook, Inc. as Facebook™, Facebook, Inc., Instagram, WhatsApp, Onavo, Beluga, Facebook.com, and other variants. In the same scenario, an embodiment of the computing environment 101 may perform entity resolution to identify all dataset entries that include a variation of Facebook, Inc., and replace the identified dataset entries with the standard employer name Facebook, Inc.

The data store 113 can store various data that is accessible to the various elements of the computing environment 101. In some embodiments, data (or a subset of data) stored in the data store 113 is accessible to the computing device 105 and one or more external systems (e.g., on a secured and/or permissioned basis). Data stored at the data store 113 can include, but is not limited to, user data 115, location data 117, position data 119, recruitment data 121, and model data 123. The data store 113 can be representative of a plurality of data stores 113 as can be appreciated. In some embodiments, information derived from user data 115, location data 117, position data 119, recruitment data 121, and data sources 103 are referred to as position “metadata.” In various embodiments, user data 115, location data 117, position data 119, and recruitment data 121 can be generally referred to as “entity data.”

The user data 115 can include information associated with one or more user accounts. For example, for a particular user account, the user data 115 can include, but is not limited to, an identifier, user credentials, and settings and preferences for controlling the look, feel, and function of various processes discussed herein. User credentials can include, for example, a username and password, biometric information, such as a facial or fingerprint image, or cryptographic keys such as public/private keys. Settings can include, for example, communication mode settings, alert settings, schedules for performing machine learning and/or communication generation processes, and settings for controlling which of a plurality of potential data sources 103 are leveraged to perform machine learning processes.

In one example, the settings include a configuration parameter for a particular position location or region. In this example, when the configuration parameter is set to a particular region, a machine learning and/or natural language generation process can be adjusted to account for a work culture or other set of factors with which the particular region is associated. Various regions and sub-regions of the world may demonstrate varying work cultures. Because work culture may vary, data that is useful in generating effective remote role recommendations may also vary, in addition to variances in magnitudes of impact and impact directionality imposed on machine-learned predictions.

In one example, work culture of a first region is such that individuals in the region typically conduct ten remote meetings each week, and work culture of a second region is such that individuals in the region typically conduct zero remote meetings each week. In this example, the computing environment 101 receives a user input defining a minimum number of remote meetings of about five meetings and, in response, the model service 109 configures a setting that excludes locations in the second region from subsequent remote role recommendations. In another example, the computing environment 101 can identify other criteria for the job positions, such as that the job position involves an average of three remote meetings per week based on position data 119 and other data including entity data describing individuals associated with the entity (e.g., employees, contracted hires, etc.). The computing environment 101 can exclude job positions based on position data failing to meet the determined criteria.

In another example, work culture of a particular region may be such that employers typically require employees to report to the office at 8 am. In this example, the model service 109 may assign a greater weight level to location criteria defining whether a particular location in the region includes particular pools of talent (e.g., locations where employees have consistently reported to the office at 8 am or earlier). Continuing with the previous example, the model service 109 may determine that reporting to an office at a particular time is detrimental to remote workability. In various embodiments, the model service 109 may configure one or more machine learning and/or NLP processes to account for variations in work culture. For example, the model service 109 may alter one or more machine learning parameter weights to reduce an impact or change impact directionality on likelihood predictions. In the above example, the model service 109 may reduce machine learning parameter weights and/or modify parameter impact directionality for parameters including onboarding time, job latency, and job tenure, thereby reducing the parameters' impact on subsequently generated likelihood predictions.

The location data 117 can refer to information associated with one or more locations from which labor may be recruited. The location data 117 can include, but is not limited to, addresses for offices and other job sites, economic data associated with a particular location (e.g., housing costs, cost of living, mortgage rates, etc.), academic data associated with a particular location (e.g., average level of education, prevalence of various degrees, proximities of universities, etc.), and rules, codes, regulations, and laws associated with a particular location (for example, laws governing minimum wage, hiring quotas, benefits, etc.). The location data 117 can include weather data, crime statistics, traffic statistics, environmental data, and talent pool distribution across various tasks, skills, and job titles. The model service 109 or data service 107 can normalize various fields in location data 117, such as, for example, generating binary values “yes” or “no” values for specific rules, codes, regulations, and laws (e.g., whether minimum wage is above or below a threshold).

The position data 119 can refer to data associated with employment opportunity and fulfillment information. Position data 119 can include, but is not limited to, position titles, position duties, responsibilities, and tasks. Position data 119 may include position locations, such as, for example, a list of current and previous addresses to which candidates holding a position have been located. Position data 119 may include position fulfillment history, such as, for example, past and current position holders, position providers (e.g., institutions, companies, etc. that offer or provide labor filling CCG-based positions), salary and/or wage information, position reviews, position provider reviews, and resumes, C.V.'s, or the like, of past and current position holders. Position data 119 may include past and current position holder education histories, job satisfaction (for example, job and/or workplace reviews related to any number of current or past-held positions), age, family status(es), marital status(es), past and current debt obligations, past and current financial health, (for example, a credit score), and social media activities. In some embodiments, the prediction system 100 is configured to process a position holder's resume and/or employee files and determine various position data 119, such as a work history, education history, and location history. The model service 109 or data service 107 can normalize various fields in position data 119, such as, for example, adjusting title descriptions to match a predetermined title (e.g., “Sales Manager I” and “Manager of Sales I” can be adjusted to both correspond to the same position code or title).

The recruitment data 121 can refer to data associated with an employment opportunity, such as a desired set of experiences or other criteria. In one example, the recruitment data 121 includes candidate criteria, such as desired experience (e.g., skills and/or work history), location, education, compensation history and/or requirements, and other candidate qualifications. In another example, the recruitment data 121 includes location criteria defining one or more desired qualities or properties of a location from which labor may be recruited.

The recruitment data 121 can include data describing one or more candidates (e.g., generally referred to as “candidate data”). The candidate data can include, but is not limited to, candidate names, location tracking data, such as, for example, a list of current and previous addresses, education history, job satisfaction (e.g., job and/or workplace reviews), age, family status, marital status, debt obligations, financial health (for example, a credit score), and social media activities (e.g., such as a list of followers, postings, etc.). In one example, candidate data includes work history, such as past and current job titles, positions, roles, employers, salary and/or wage information, candidate performance reviews, job locations, and resumes. In at least one embodiment, personally identifying data, financial data, social media data, and other personal data (e.g., family and marital status, etc.) may not be collected or leveraged or may be intentionally excluded for processes described herein (e.g., in accordance with legal policy, corporate policy, data privacy policy, user consent parameters, etc.). In some embodiments, candidate data includes criminal records, degree history, liens, voting history, and other data obtained from investigative processes (e.g., such as information obtained from a background check performed on a particular candidate). The candidate data can include assets owned by candidates including timing information as to when those assets were purchased, such as, for example, real estate including primary residences and secondary residences, vehicles, boats, planes, and other assets. The candidate data can include current estimated values and debts associated with each asset. The model service 109 or data service 107 can normalize various fields in recruitment data 121, such as, for example, normalizing background check information to fit into predetermined bins (e.g., whether a candidate has a criminal record, whether a candidate's credit score is above a predetermined threshold, whether the candidate attended a university ranked at or above a predetermined threshold).

The model data 123 can include data associated with machine learning and other modeling processes described herein. Non-limiting examples of model data 123 include, but are not limited to, machine learning models, parameters, weight values, input and output datasets, training datasets, validation sets, configuration properties, and other settings. In one example, model data 123 includes a training dataset including historical location data 117, recruitment data 121, and position data 119. In this example, the training dataset can be used for training a machine learning model to estimate one or more remote or on-site job positions.

In various embodiments, the model data 123 may include work culture categories that can be provided as an input to machine learning processes. In at least one embodiment, a work culture category may be used by the modeling service 109 to modify data that is input to and analyzed via one or more machine learning models. In one embodiment, a work culture category may be used by the modeling service 109 to modify outputs generated by one or more machine learning models. For example, a work culture category associated with a work culture that emphasizes in person meetings may cause a machine learning model to downgrade classifications or reduce metric scores for positions associated with the work culture category. In one embodiment, the data stored in the data store 113 can exclude specific types of information from being used in analyses to ensure fair and equal treatment, e.g., to avoid excluding someone based on marital status, gender, race, sexual preference, etc.

In one or more embodiments, a work culture category may be used by the modeling service 109 to cause one or more machine learning models to initialize parameter weights at a higher or lower magnitude, or with a positive or negative directionality. For example, a work culture category for a “Country X” may be input to a machine learning process for evaluating remote potential of positions within Country X. In the same example, the Country X work culture category may cause one or more machine learning models to exclude input data related to entity data associated with locations outside of Country X (e.g., establishing that entity data outside of Country X are not predictive for predicting remote potential of positions in Country X). In some embodiments, the model service 109 identifies (e.g., and uses as an input to machine learning processes) utilities and other amenities available at the location or country with which a position is associated, such as availability of raw materials, available internet speeds, external temperatures/weather, and available tax benefits.

In various embodiments, the data source 103 can refer to internal or external systems, pages, databases, or other platforms from which various data is received or collected. Non-limiting examples of data sources 103 include, but are not limited to, human resources systems, recruitment systems, real estate and other housing information systems, resume processing systems, applicant and talent pools, public databases (e.g., commercial record systems, tax systems, criminal record systems, company information databases, university systems, social media platforms, and etc.), private and/or permissioned databases, webpages, and financial systems. In one example, a data source 103 includes a social networking site for professional development from which the computing environment 101 collects and/or receives job descriptions and related information (e.g., such as information relating to a company associated with the job description or similar job descriptions). In another example, a data source 103 includes a geolocation service from which the computing environment 101 retrieves addresses and other location data. In another example, a data source 103 includes a database of rules, such as a corpus of active codes, regulations, and laws for a particular location, company, or position.

The computing device 105 can be any network-capable device including, but not limited to, smartphones, computers, tablets, smart accessories, such as a smart watch, key fobs, and other external devices. The computing device 105 can include a processor and memory. The computing device 105 can include a display 125 on which various user interfaces can be rendered by a remote work application 129 to configure, monitor, and control various functions of the prediction system 100. The remote work application 129 can correspond to a web browser and a web page, a mobile app, a native application, a service, or other software that can be executed on the computing device 105. The remote work application 129 can display information associated with processes of the prediction system 100 and/or data stored thereby. In one example, the remote work application 129 displays remote work profiles that are generated or retrieved from the data store 113. In another example, the remote work application 129 displays a ranked list of job positions classified as “remote” or, in another example, displays a ranked list of job positions' qualities that most positively and negatively contributed to a machine learning model output.

The computing device 105 can include an input device 127 for providing inputs, such as requests and commands, to the computing device 105. The input devices 127 can include a keyboard, mouse, pointer, touch screen, microphone for voice commands, camera or light sensing device to reach motions or gestures, or other input devices. The remote work application 129 can process the inputs and transmit commands, requests, or responses to the computing environment 101 or one or more data sources 103. According to some embodiments, functionality of the remote work application 129 is determined based on a particular user account or other user data 115 with which the computing device 105 is associated. In one example, a first computing device 105 is associated with a company user account and the remote work application 129 is configured to display remote work profiles and provide access to remote work evaluation and recommendation processes. In this example, a second computing device 105 is associated with an office user account or a candidate user account, and the remote work application 129 is configured to allow the computing device 105 to transmit location data 117 and position data 119 to the computing environment 101 and to display communications, such as staffing messages and alerts.

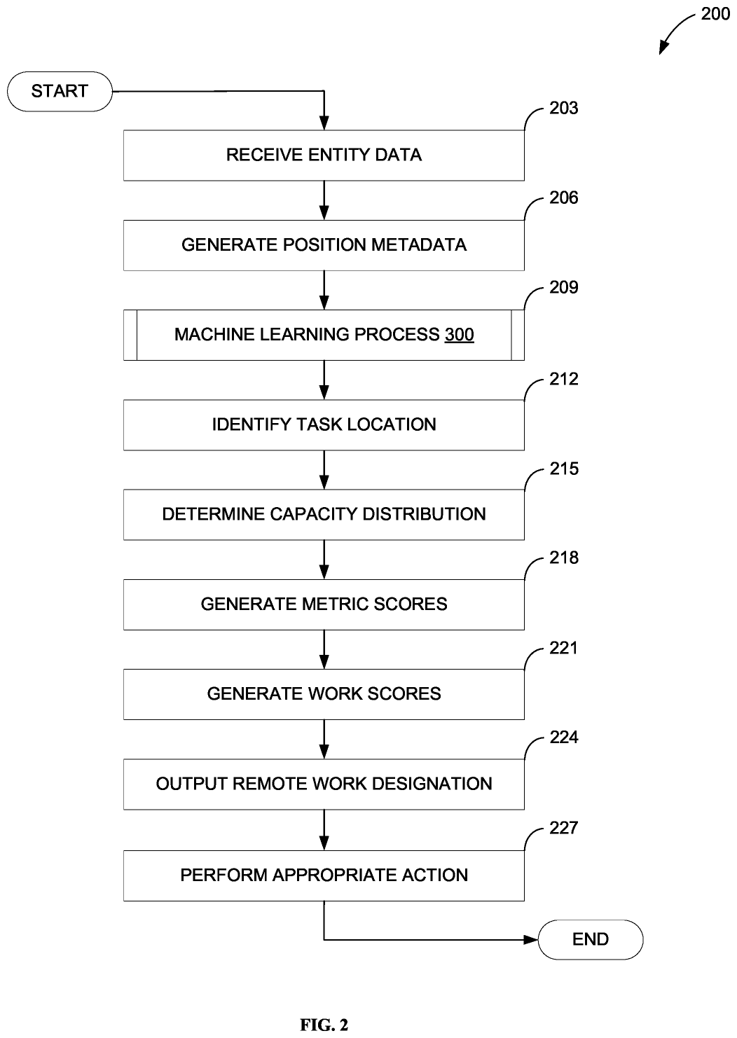

Referring to FIG. 2, shown is a flowchart of a process 200 according to various embodiments of the present disclosure. In particular embodiments, the process 200 corresponds to a machine learning operation for determining whether a job position may be performed virtually or remotely.

At step 203, the process 200 includes receiving entity data. As an example, the data service 107 can receive, collect, extract, or obtain data from one or more computing devices 105, data sources 103, or the data store 113. In various embodiments, the computing environment 101 receives entity data from a variety of sources, such as a job description, a job position, other forms of transmissible communications regarding a job position (e.g., recorded audio, video recordings, interviews), local and/or private databases, licensed databases, the Internet, publicly accessible databases, a user input, and/or any other form of data repository. In some embodiments, the entity data includes information regarding a job description, such as job title, company name, required skills, and/or other information contained in the analyzed source. Entity data may also include information regarding individuals that currently, or historically, have held the job position, or similar job positions, as the one being analyzed—referred to herein as individual entity data. In one or more embodiments, the job description, or other information sources, received by the data service 107 is input by a user via the computing device 105. In various embodiments, the data service 107 and/or the model service 109 monitors for changes to and scrapes information from various data sources 103 (e.g., by using a variety of suitable coded and/or machine learning techniques). In at least one embodiment, a user may be a person within a company that posts job positions, a system associated with a company, or an individual using the disclosed system. A job position may refer to a particular job currently held by an individual in a company or a future position that can be held by a current or new employee. A job description may refer to a text, or any other form of transmissible information, that describes the various aspect of the job position it is describing.

In various embodiments, the computing environment 101 may leverage one or more deep/machine learning and natural language processing techniques through the data service 107 to parse and/or categorize the entity data from the job description. In one embodiment, the natural language processing techniques may include, but are not limited to, keyword matching and/or topic modeling. For example, a user inputs a job description as a text file, or any other form of transmissible information, and the modeling service 109 and/or the data service 107 uses the machine learning and natural language processing systems to extracts key words pertaining to the job position. In another example, the machine learning and natural processing system actively explores other forms of transmissible information regarding a job position and extract entity data pertaining to the particular job position. The data service 107 can periodically and automatically spider or crawl over websites that include job postings to identified posted jobs and collect the data.

In particular embodiments, the data service 107 also receives entity data by parsing through current and historical job position data stored in one or more databases in the data store 113 and/or a network accessible data sources 103. Locally or privately stored databases may be defined as company based servers, licensed or non-licensed databases from other companies, and/or any other form of databases non-accessible to the public. In various embodiments, publicly accessible data sources are defined as databases found on the internet, public government databases, and/or any other form of publicly accessible database. Job position data may include, but is not limited to, job position titles, job position duties, date of posting, date job posting first identified, responsibilities, tasks, skills, etc., and job position locations. In some embodiments, the data service 107 may assess the data from the job description and other resources to determine additional relevant information via machine learning algorithms and natural language processing, by utilizing additional resources such as standard occupation codes, ONET codes, or other standards, for formalizing the structure and modeling of the job position looking to be filled. For example, in one embodiment, a job description may only contain a position title, wherein the data service 107 may parse through stored information in proprietary databases and/or publicly available databases containing job position data, such as the additional resources from above, to determine the skills, tasks, and responsibilities for the job position. In one or more embodiments, the disclosed computing environment 101 may also determine the industry of the company from the company name, by parsing through public records and utilizing natural language processing techniques, such as those described below.

In various embodiments, step 203 includes receiving individual entity data pertaining to a particular job position. In various embodiments, the data service 107 receives individual entity data through the data store 113, the data source 103, a job description from a job position, a publicly accessible database, and/or any other form of data storage or information pertaining to a particular user and/or job position. In at least one embodiment, the individual entity data includes information regarding a particular person associated with the company (e.g., an employee, a prospective candidate, a former employee). In some embodiments, the data service 107 can aggregate a plurality of individual entity data sets to formulate a searchable repository. In various embodiments, the individual entity data includes, but is not limited to, a person's name, a person's age, a person's office (if applicable), a person's department, a person's pay grade, and/or a person's job title.

At step 206, the process 200 includes generating job position metadata based on previously received entity data. In one or more embodiments, the generated job position metadata includes received, collected, or otherwise accessed data regarding a specific job description or job position. In various embodiments, metadata also includes any dataset stored in the data store 113 and/or data source 103 that pertains to a particular job position or job description. In one example, a dataset can include a predefined datasets describing known job positions. Continuing with the previous example, the computing environment 101 may include metadata with one or more datasets describing known job tasks, skills, and/or responsibilities that can be performed remotely. In particular embodiments, the metadata is attached to at least one aspect of the job description or job position (or otherwise associated in memory with the job position). For example, a user inputs a job description as a text file, or any other form of transmissible information, and the data service 107 uses the machine learning and natural language processing systems to extracts key words pertaining to the job position. Continuing with the previous example, the data service 107 stores the analyzed key words as metadata and attaches the metadata to the corresponding job description and/or job position.

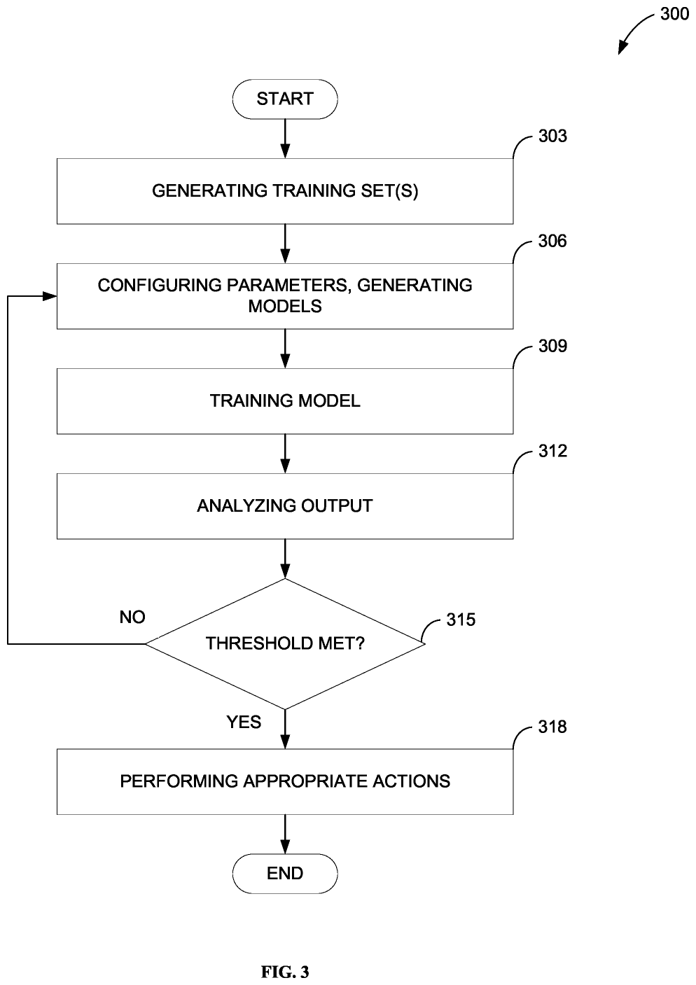

At step 209, the process 200 includes performing one or more machine learning processes 300 (FIG. 3). In at least one embodiment, the model service 109 may use one or more machine learning techniques from the machine learning process 300 for determining a score related to a particular feature of a job or skill or whether a particular job or skill can be performed remotely (such use cases will be described herein). In some embodiments, the model service 109 may determine various other factors by one or more supervised or unsupervised machine learning models/techniques.

At step 212, according to one embodiment of the present disclosure, the process 200 includes identifying task locations with respect to a company and its job description or job position. In some embodiments, the task locations of a company is synonymous with the office locations of the same company. In various embodiments, the identification of a task location is performed by determining the office locations within the company using the company name to search public records. In particular embodiments, other searchable resources for the task locations of a particular company includes local and/or private databases, publicly accessible databases, the Internet, or any other form of transmissible information regarding the company. In at least one embodiment, the data service 107 identifies the company by analyzing received, collected, or otherwise accessed information, or metadata, pertaining to the job description or job position. In various embodiments, the model service 109 may collect a name of the company, or any information useful for determining a task location, using natural language processing techniques on the original job description or any other form of transmissible information pertaining to a job position. In an alternate embodiment, the data service 107 may determine the company name from the system associated with the company that provided the initial job position data. In one or more embodiments, once the computing environment 101 determines the company name, the computing environment 101 may determine the office locations of the company by parsing through public records databases or other databases. In particular embodiments, the data service 107 will save task location information for future processing of current or perspective remote work recommendations.

At step 215, according to one embodiment of the present disclosure, the process 200 includes determining the distribution of talent of a particular job position or job description (e.g., also referred to as a “distribution of capacity”). In various embodiments, the talent distribution can also refer to the talent across the company's office locations for a particular job position or job description. In particular embodiments, distribution of capacity is an estimation of the quantity and quality of particular position holders at each of a plurality of locations. In at least one embodiment, the estimation is calculated using a variety of talent metrics for the employees at each location (e.g., experience, qualifications, productivity). In various embodiments, the estimations of each individual employee can be aggregated to formulate an overall distribution of capacity for a particular location and/or region. In one or more embodiments, the computing environment 101 uses received, collected, or otherwise accessed information from the job description, a plurality of individual entity data, job position, publicly accessible records, and/or other databases to determine the talent distribution across the company's office locations. In some embodiments, the talent distribution may reveal whether a particular office location has a high or low existing amount of talent for the job position or job description.

At step 218 according to one embodiment of the present disclosure, the process 200 includes generating one or more defined metric scores based on various factors, such as job metadata, the distribution of capacity, the number of office locations, type of job, the amount of time a person in that job position needs to be in the office, access to high seep internet at the home of a person in that job position, and/or other similar types of work factors pertaining to a company and/or job position. In at least one embodiment, the defined metric score is generated by the model service 109 using machine learning techniques or any other suitable calculation methods. In one or more embodiments, the defined metric score measures any metric used to quantify different factors pertaining to a particular job position (e.g., proximity scores, collaboration scores, and engagement scores).

In particular embodiments, the model service 109 produces a physical proximity score, which is a numerical value assigned to a singular skill or task associated with the job position. In various embodiments, the physical proximity score quantifies to what degree a task or skill can be performed in or out of a particular office. Furthermore, a physical proximity score may also include a scaled numerical estimate (or other classification) of a factor's positive contribution to in person performance (e.g., a high proximity score indicates that a job is likely suitable for in person performance). For example, in one embodiment, the model service 109 may assign a high proximity score for a certain tasks associated with a job position because all employees that perform that task may work together in one office location, thus making it likely that a person hired to the same job position would need to work at the same office location as the others in the same job position. In an alternate example, the model service 109 may assign a low proximity score for a certain task associated with a job description because most or all of the employees associated with that task work remotely from home, meaning it is more likely that the job can be performed virtually.

In at least one embodiment, the model service 109 can further determine and output a proximity score for a particular job position by comparing predefined datasets describing known job positions to the current metadata of the job position or job description. In particular embodiments, the data store 113 may include one or more datasets describing known job tasks, skills, and/or responsibilities that can be performed remotely. In one or more embodiments, the data service 107 and the model service 109 may analyze a job position or job description to determine if known job positions or tasks and skills within the job description that can be performed remotely are included. For example, in one embodiment, the computing environment 101 may scrape job position data for a job posting on the Internet, wherein the job position data indicates that the job position is a remote job position. In the same example, once the computing environment 101 determines that a job position is a remote job position as stated in the job posting, the computing environment 101 may thereafter associate the individual job position data (e.g., certain skills and tasks) within the job posting with a physical proximity score of “remote.” Continuing with the example, if the computing environment 101 recognizes the same or similar job position data in a new job posting, the computing environment 101 may determine that the individual job position data receives a physical proximity score of “remote,” regardless of whether the employer listed the job position as remote or not.

In various embodiments, an alternate defined metric score generated by the computing environment 101 is a collaboration score. In one or more embodiments, a collaboration score measures the degree to which a task of a particular job position can be performed collaboratively. The computing environment 101 may determine collaboration scores according to one or more embodiments described in the incorporated disclosures, such as, for example U.S. Patent Application No. 63/035,379, filed Jun. 5, 2020, titled “COLLABORATION IDNEX.”

In at least one embodiment, an alternate defined metric score generated by the computing environment 101 is an engage score. In particular embodiments, the engage score quantifies a candidate's risk or inclination to respond to a recruitment technique (e.g., a recruitment email, a recruitment seminar, and a career fair), leave their current role, or other forms of engagement metrics. The computing environment 101 may determine engagement scores according to one or more embodiments described in U.S. patent application Ser. No. 16/546,849, filed Aug. 21, 2019, titled “MACHINE LEARNING SYSTEMS FOR PREDICTIVE TARGETING AND ENGAGEMENT,” the disclosure of which is incorporated herein by reference in its entirety.

In particular embodiments, a defined metric score for each associated task of a particular job position or job description is aggregated to formulate an average defined metric score. The computing environment 101 may analyze each individual defined metric score for each task of a particular job description or access the averaged defined metric score for further processing described herein. For example, if a proximity score is measured on a scale of 0 to 5, where 5 represents “least likely to be remote” and 0 represents “most likely to be remote” (e.g., or “least likely to be in person”), and a plurality of proximity scores aggregated for each task of a particular job position averages to 4.9, it is likely that the particular job position is less likely to be remote (e.g., or “most likely to be in person”). In one or more embodiments, averaging techniques include, but are not limited to, arithmetic mean, geometric mean, harmonic mean, quadratic mean, weighted mean, root mean square, generalized mean, mode, median, and/or geometric median. In particular embodiments, the proximity score can further be aggregated, scaled, and/or averaged for further processing desires, such as, but not limited to, error calculations, predictability, and statistical analysis.

At step 221, according to one embodiment of the present disclosure, the process 200 includes generating a work score based on the plurality of defined metric scores. In some embodiments, the work score is attributed to the skills and/or tasks associated with a job description and any other metadata that pertains to a particular job position and/or job description. In particular embodiments, the work score is generated by the computing environment 101 using machine learning algorithms or any other suitable calculation method. In various embodiments, the computing environment 101 uses one or a plurality of defined metric scores to calculate the work score for a particular job position. In one or more embodiments, the computing environment 101 uses machine learning techniques to determine a numerical score that measures the ability for an individual in the particular job position to work remote.

The system can combine work scores to generate the overall work scores. As an example, the system can use predetermined weightings to combine the work scores into the overall work scores. In some embodiments, the system can determine weightings for combining the work scores. In other embodiments, the system can receive user configurable weightings for use in combining the work scores. In some embodiments, the system can determine weightings for combining the work scores. The system can customize the weightings for each particular job description using metadata. As an example, the system can generate a greater weighting for expected time in office at the location when the expected time in office of a posted job position includes an expected time in office range that is below a market average of expected time in office for the job title.

In particular embodiments, the computing environment 101 can rank the work scores of a plurality of job position to determine which job position is best suited for remote or on-site work. In various embodiment, a ranking system can be created for any defined metric score. In one or more embodiments, generating the ranking includes generating a classification of the work score based on Equation 1 (which can include e.g., a step function), in which h(x_{ijg}) is a machine-learned prediction from the one or more machine-learned predictions, h₀ is a predefined “suitable positon for remote” threshold, h₁ is a predefined “potentially suitable” threshold, h₂ is a predefined “likely suitable” threshold, and c(x_{ijg}) is the classification to which each one the one or more machine-learned predictions is assigned. In some embodiments, the process 200 only generates work scores and classifications, and does not generate a ranking.

$$c ( {x}_{ijg} ) = \{ \begin{matrix}position least likely to be remote if h ( {x}_{ijg} ) \leq {h}_{0} \\ position may be remote if {h}_{0} \leq h ( {x}_{ijg} ) \leq {h}_{1} \\ positioin more likely to be remote if {h}_{1} < h ( {x}_{ijg} ) \leq {h}_{2} \\ postion most likely to be remote if h ( {x}_{ijg} ) > {h}_{2}\end{matrix} \qquad ( Equation 1 )$$

At step 224, according to one embodiment of the present disclosure, the process 200 includes outputting a remote work designation based on the work score produced by the model service 109. In particular embodiments, the computing environment 101 has a predefined range used to match work scores to a specific remote work designation. In various embodiments, the remote work designation refers to a likelihood that a particular job position or job description can be performed remotely, or locally. In one example, a computing environment 101 is predefined with a work designation spectrum where 0-2 designates “on-site,” 2.1-4 designates “near remote,” and 4.1-5 designates “fully remote,” where “fully remote” indicates that the job position can be performed virtually, “near remote” indicates that the job position can be performed virtually but within a particular distance of the company's office, and “on-site” indicates that the job position must be performed in person. In a further embodiment, other additional remote working designations or spectrum resolution/ranges may be utilized to further specify the remoteness of the job position. Continuing the previous example, a remote work score of 2.4 is matched to the work designation scale and the computing environment 101 outputs a work designation of “near remote.” In various embodiments, the computing environment 101 may output either or both of the remote work score and remote working designation to the user.

At step 227, according to one embodiment of the present disclosure, the process 200 includes performing appropriate actions. In one example, the computing environment 101 aggregates all metadata, defined metric scores, job positions, job descriptions, work scores, and remote work designations into a dataset for further use. Continuing with the same example, the computing environment 101 links the particular metadata, defined metric scores, and other job position related information if the system, or a user, deems the information to be related. In particular embodiments, the information is further processed through a user interface and displayed to the user through the computing device 105. For example, the computing environment 101 can transmit one or more machine learning models to one or more computing devices 105. Continuing with the previous example, the machine learning models are displayed on the display 125 of the one or more computing devices 105. In various embodiments, the computing environment 101 generates a database that can be used by the entity (e.g., and users approved thereby) for data analysis and other business management purposes. In some embodiments, the computing environment 101 generate automated responses based on particular generated information or outputted data. In at least one embodiment, the computing environment 101 transmits an output in the form of an alert, text message, electronic mail, push notification, instant message, document (e.g., a word document, PDF, etc.), spreadsheet (for example, a CSV file or Excel file), or presentation file (for example, a PowerPoint file). In one example, the computing environment 101 transmits to the computing device 105 a list of remote work job positions. In another example, the computing environment 101 transmits a work score and one or more additional scores (e.g., collaboration score, location score, etc.) of a remote job position to the computing device 105. In another example, the computing environment 101 generates and hosts a report at a particular networking address that is accessible via the remote work application 129 and/or a browser of the computing device 105.

In various embodiments, the remote work application 129 causes the computing device 105 to render an interface that includes the most influential parameters for each a remote work job position (for example, in the form of a table or other suitable graphic). In at least one embodiment, the computing environment 101 generates a searchable report that details each parameter for each job position (e.g., or a subset of job positions), the metric score for each parameter, the ranking of each parameter for each job position relative to the like-factors of other job positions, and/or a statistical analysis between the factors that cause a job to be considered remote versus on-site. In some embodiments, the remote work application 129 causes a spreadsheet application on the computing device 105 to render a searchable repository including one or more job positions and corresponding work scores, classifications, and/or additional factors. In at least one embodiment, other types of actions are performed on the produced information and particular outputs are created accordingly.

Referring to FIG. 3, shown is the machine learning process 300 according to various embodiments of the present disclosure. In particular embodiments, the machine learning process 300 describes exemplary procedural steps for the model service 109. In various embodiments, the machine learning process 300 is performed by the model service 109 to generate predictions of whether a job position may be performed remotely. In an alternative embodiment, the machine learning process 300 is performed by the model service 109 to preform various machine learning and natural language processing techniques for a variety of applications. The various applications of the machine learning process 300 may include, but are not limited to, word recognition, data analysis, data interpretation, word classifications, defined metric score generation, work score generation, and/or work designation generation. In one or more embodiments, machine learning methods may include, but are not limited to, neural networks, gradient boosting algorithms, mutual information classifiers, random forest classification, and other machine learning techniques and related algorithms. In particular embodiments, the machine learning process 300 is used to analyze any collection of metadata, data sources 105, data store 113, and/or any information pertaining to a job position. In various embodiments, machine learning model generation, execution, and training may be performed according to one or more equations.

In one or more embodiments, the model service 109 uses the machine learning process 300 to leverage one or more algorithms to evaluate, analyze, and classify data inputs, and generate and classify outputs. For example, an embodiment of the model service 109 may include algorithms including, but not limited to one or more remote roll recommendation engine algorithms.

In various embodiments, the model service 109 uses the machine learning process 300 to generate an input dataset of job position data describing a plurality of job positions. In at least one embodiment, the model service 109 may execute the trained machine learning model on the input dataset, and the trained machine learning model may output a set of likelihood predictions (e.g., Booleans, scores, etc.) describing, for each job position or job task, a likelihood of being an on-site job position.

In at least one embodiment, the model service 109 using the machine learning process 300 may also output or identify, for each job position, one or more portions of the input dataset that were most influential upon the job position's associated likelihood prediction. In one or more embodiments, to identify and report the most influential portions, the model service 109 may determine one or more machine learning parameters (formed from the input dataset) that were most heavily weighted. In at least one embodiment, the model service 109 may identify one or more most-weighted machine learning parameters that positively influenced a likelihood prediction, and may also identify one or more most-weighted machine learning parameters that negatively influenced a likelihood prediction. By identifying and reporting most-weighted parameters, the model service 109, in various embodiments, may provide for identification and tracking of parameters and job position factors that are most important in evaluating job position on-site or remote status.

At step 303, according to one embodiment of the present disclosure, the machine learning process 300 includes generating one or more training datasets. In at least one embodiment, training the machine learning model includes generating parameters and coefficients in the machine learning model using training data that includes known outcomes such that the parameters and coefficients cause the machine learning model to be predictive for the training data of the known outcomes (e.g., based on determining correlations in inputs from the training data predictive of the known outcomes). In various embodiments, the model service 109 may generate a first training set including a first portion including job position data describing known on-site job positions and a second portion including job position data describing known remote job positions. According to one embodiment, a training dataset or dataset may refer to a set of historical data that is evaluated by a machine learning model. The machine learning model can evaluate the training dataset for the purposes of improving model accuracy, reducing error, or otherwise improving the model. A training dataset (also referred to as a “teaching” dataset) can include labeled or unlabeled data (e.g., the labeled data including a known output with which the data is associated). In one example, to identify particular job positions that are remote or non-remote based positions, a first training dataset and second training dataset are generated that includes a first portion including job position data describing known on-site job positions, and a second portion is generated that includes job position data describing known remote job positions.

In some embodiments, generating the training dataset includes generating or retrieving one or more datasets describing known on-site job positions and/or known remote job positions. In this example, the data service 107 evaluates user data 115, position data 119, and other data to determine if a particular job position is a known on-site job positon and/or to determine if a particular job position is a known remote job position. The data service 107 can analyze a particular job position and its corresponding job description, or any other form of pertinent information regarding the job position, to determine if the analyzed job position is a remote or on-site job. Continuing the example, in response to identifying if the analyzed job position is remote or on-site, the model service 109 includes the determinations (e.g., and/or data that contributed to the determinations) as parameters of a training dataset for predicting a measurable metric for whether a job position is remote, on-site, or any degree between the two aforementioned states.

In at least one embodiment, the model service 109 may generate a second training set including candidate and/or position data describing both known on-site job positions and known remote job positions. In various embodiments, the second training set may be absent information that identifies job positions therein as on-site job positions or remote job positions.

At step 306, the process 300 includes configuring one or more parameters and generating a machine learning model (e.g., based on the one or more parameters). Configuring the one or more parameters can include adjusting one or more parameters to reduce an error metric, increase an error metric, or improve other output-related metrics. In at least one embodiment, to reduce the error metrics, the model service 109 may perform actions including, but not limited to, identifying one or more most-erroneous parameters that most heavily contributed to error metrics, excluding one or more identified most-erroneous parameters from further machine learning processes, increasing and/or decreasing various parameter weights such that identified most-erroneous parameters may contribute less to the one or more error metrics may be reduce, and executing one or more loss function optimization algorithms.

The model service 109 can configure the one or more parameters by adjusting one or more weight values based on output of another machine learning model. In an exemplary scenario, a first machine learning process is performed to train one or more machine learning models to determine if a particular job position is remote or on-site. By the first machine learning process, differences, correlations, and data patterns between remote job positions and on-site job positions are determined and leveraged to generate a secondary machine learning model to predict a likelihood of a particular job position being on-site, remote, or a degree between the two aforementioned states.

Continuing the exemplary scenario, a training dataset is generated based on sets of historical position data 119 (and/or other data) with which known remote job positions and on-site job positions are associated, respectively. The training dataset includes data describing 10,000 known remote job positions and 10,000 known on-site job positions. Using the training dataset, the first machine learning model is trained to predict a classification of job positions either as remote, on-site, or a degree between the two aforementioned states. The first trained machine learning model is configured to assign initial weights and/or directionality to various parameters (e.g., job position data, and other information) that are generated from the training dataset (or other input data). From the training process, the model service 109 determines that conducting five in-person meetings a week is negatively predictive for a particular job position to be a remote job. Based on the determination, the model service 109 assigns a negative directionality to the identified parameter, thereby indicating that a job position's demonstration of the identified parameter should cause a machine learning model to decrease the job position's predicted likelihood of being a remote job position.

In the same scenario, the model service 109 determines that having zero in-person meetings a week is positively predictive for a particular job position to be remote. Based on the determination, the model service 109 assigns a positive directionality to the identified parameter, thereby indicating that a job position's demonstration of the identified parameter should cause the first trained machine learning model to increase the job position's predicted likelihood of being a remote job position. The magnitude of each directionality is determined based on the weight value with which the parameter is associated and which was generated by the trained first machine learning model.

Continuing the exemplary scenario of the preceding paragraphs, a second machine learning process is performed to generate one or more secondary machine learning models based on the first trained machine learning model. The secondary machine learning model is trained to predict one or more likelihoods of each of the 10,000 known remote job positions and each of the 10,000 known on-site job positions as being a remote job position. The secondary machine learning model can be trained on using the determinations of the first machine learning model, such that determined trends, weights, directionalities, and other parameter-influencing factors are leveraged to improve the performance of the secondary machine learning model.

At step 309, the process 300 includes training a machine learning model (e.g., using one or more training datasets). Training the machine learning model can include, but is not limited to, executing the machine learning model on an input (e.g., a training dataset or subset thereof) and generating an output, such as a prediction score or classification. In one or more embodiments, the model service 109 generates and trains, using the first training dataset, one or more primary machine learning models to identify differences between known remote job positions first dataset portion and known on-site job positions second dataset portion. In at least one embodiment, by identifying the differences, the one or more primary machine learning models may be trained to identify remote or on-site job position criteria (e.g., position data, etc.) that are predictive for known remote or on-site job positions. According to one embodiment, one or more subsequent machine learning models may be created from the one or more primary machine learning models, and may be configured to analyze job positions and predict a likelihood that a particular job is a remote job, an on-site job, or a degree between both aforementioned states. In at least one embodiment, the model service 109 generates and trains one or more primary machine learning models to identify differences between a particular remote job position dataset portion and a particular on-site job position dataset portion.

In one or more embodiments, the model service 109 may generate and train, using a first training dataset, one or more first machine learning models to identify respective differences between a remote job position dataset and an on-site job position dataset. In at least one embodiment, by identifying the differences, the one or more first machine learning models may be trained to identify job position criteria (e.g., candidate data, etc.) that, for example, are predictive for on-site or remote job positions. In various embodiments, one or more subsequent machine learning models may be created from the one or more first machine learning models, and may be configured to analyze job positions and generate predictions therefor.

One or more secondary training datasets can be generated, for example, to support unsupervised (e.g., unlabeled) training or supervised (e.g., labeled) training. In at least one embodiment, the model service 109 generates a secondary training dataset that includes, for example, position data 119 and/or recruitment data 121 describing both known remote and known on-site job positions. In various embodiments, the model service 109 may generate a secondary training dataset including position data 119 and/or recruitment data 121 describing both known remote and known on-site job positions. In at least one embodiment, the second training dataset may be unlabeled (e.g., absent information that identifies job positions therein as remote or on-site). In one or more embodiments, one or more secondary machine learning models may be trained to predict, from the second training dataset, how remotely a job can be performed. According to one embodiment, the one or more secondary machine learning models may generate a first set of predicted remote or on-site positions. In one or more embodiments, the one or more secondary machine learning models may be trained to predict, from the second training dataset, job positions that are remote or on-site.

At step 312, the process 300 includes analyzing output from one or more training models. Analyzing the output can include, but is not limited to, comparing the output to an expected output and, based on the comparison, computing one or more accuracy or error metrics (also referred to as loss functions). In at least one embodiment, the model service 109 calculates one or more error metrics between machine-predicted output and corresponding known output (e.g., from the first training dataset). In various embodiments, and may reconfigure or modify the one or more secondary machine learning models to reduce the error metrics (e.g., thereby increasing accuracy and/or precision of subsequently generated predictions).

In at least one embodiment, the model service 109 may compare the first set of predicted remote or on-site job positions to the known remote or on-site job positions of the first training dataset and calculate one or more error metrics quantifying the comparison, thereby determining how accurately and precisely the one or more secondary machine learning models identified the remote or on-site job positions.

At step 315, the process 300 includes determining that a predetermined threshold, such as an error or accuracy threshold, is met. In various embodiments, the model service 109 may repeat and iterate upon any training activities until one or more dynamic and/or predetermined error metric thresholds are met. In at least one embodiment, in response to determining that the predetermined threshold is met, the process 300 proceeds to step 318. In one or more embodiments, in response to determining that the predetermined threshold is not met, the process 300 proceeds to step 306. For example, the process 300 proceeds to step 306 to reduce model error or otherwise improve the model performance. Continuing with this example, the process 300 proceeds to step 306 when the predetermined threshold is not met and various machine learning properties must be evaluated and changed.

At step 318, the process 300 includes performing appropriate actions with the output of the machine learning model, according to one embodiment of the present disclosure. In particular embodiments, the model service 109 stores the threshold-satisfying machine learning model. The machine learning model can be stored, for example, as model data 123, including, but not limited to, training datasets, error metrics, parameters, weight values, directionality assignments, and configuration settings. In various embodiments, an appropriate action includes retraining the machine learning model using additional training datasets (e.g., to avoid overfitting the machine learning model to the first training dataset).

In at least one embodiment, an appropriate action includes generating work scores and/or classifications for a plurality of work scores by executing the trained machine learning model on data and metadata obtained at steps 203-206 of the process 200. In one example, upon determining that an iteration of the machine learning model satisfies an error, accuracy, and/or precision threshold, the model service 109 executes the trained machine learning model on entity data of step 203 and metadata derived therefrom at step 206. In this example, the trained machine learning model can generate a work score for each of a plurality of job positions defined in the entity data, and the model service 109 can classify the likelihood a job positions will be remote according to their work scores.

In at least one embodiment, an appropriate action includes performing additional iterations of the process 300 to generate and train machine learning models for predicting other metrics, such as, for example, collaboration scores, location scores, supply-demand ratios, and talent distributions. According to one embodiment, because the additional metrics may be used as inputs to the remote work determination machine learning model, the model service 109 generates and trains machine learning models for estimating the additional metrics prior to training the remote work determination model.

From the foregoing, it will be understood that various aspects of the processes described herein are software processes that execute on computer systems that form parts of the system. Accordingly, it will be understood that various embodiments of the system described herein can be implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. In some embodiments, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein.

What is claimed is:

1. A machine learning system, comprising:
a data store comprising entity data for an entity;
at least one computing device in communication with the data store, the at least one computing device being configured to:
receive data describing at least one aspect of a position for the entity;
generate metadata for the position based on the data describing the at least one aspect of the position, the metadata comprising a plurality of skills and tasks associated with the position;
identify a plurality of task locations for the entity;
determine a distribution of capacity across the plurality of task locations based on the entity data;
generate a plurality of physical proximity scores for each of the plurality of skills and tasks based on the metadata for the position, the distribution of capacity, and the plurality of task locations; and
generate a remote work score for the position based on the plurality of physical proximity scores.

2. The machine learning system of claim 1, wherein generating the plurality of physical proximity scores is further based on at least one data set comprising a plurality of known proximity scores corresponding to a plurality of known skills and tasks.

3. The machine learning system of claim 1, wherein the at least one computing device is further configured to:
determine the remote work score is below a predefined remote work threshold; and
identify at least one particular physical location for the position based on the plurality of physical proximity scores.

4. The machine learning system of claim 1, wherein the metadata further comprising at least one of: a location of the position, an identifier of the entity, and a position identifier.

5. The machine learning system of claim 1, wherein the at least one computing device is further configured to generate the metadata by parsing the data describing the at least one aspect of the position by applying a deep learning and natural language processing algorithm to the at least one aspect of the position.

6. The machine learning system of claim 1, wherein the at least one computing device is further configured to periodically capture and index publically accessible data relating to positions and store the data in the data store for use in generating the metadata for the position.

7. A machine learning method, comprising:
receiving, via at least one computing device, data describing at least one aspect of a position for an entity;
receiving, via the at least one computing device, entity data corresponding to the entity;
generating, via the at least one computing device, metadata for the position based on the data describing the at least one aspect of the position, the metadata comprising a plurality of skills and tasks associated with the position;
identifying, via the at least one computing device, a plurality of task locations for the entity;
determining, via the at least one computing device, a distribution of capacity across the plurality of task locations based on the entity data;
generating, via the at least one computing device, a plurality of physical proximity scores for each of the plurality of skills and tasks based on the metadata for the position, the distribution of capacity, and the plurality of task locations; and
generating, via the at least one computing device, a remote work score for the position based on the plurality of physical proximity scores.

8. The machine learning method of claim 7, wherein the metadata is generated further based on the entity data.

9. The machine learning method of claim 7, further comprising generating a remote working designation for the position based on the remote work score falling into a particular bin of a plurality of remote work score bins.

10. The machine learning method of claim 7, further comprising:
generating, via the at least one computing device, a training data set for the entity using the entity data, the training data set comprising first position data describing known on-premise positions and second portion data describing known remote positions; and
training, via the at least one computing device, a machine learning model using the training data set, wherein the plurality of physical proximity scores are generated via the machine learning model.

11. The machine learning method of claim 10, wherein the machine learning model is configured to identify remote working criteria predictive for on-premise or remote positions when executed by the at least one computing device, wherein the method further comprises:
generating, via the at least one computing device, a second machine learning model based on the machine learning model, the second machine learning model being configured to predict a proximate importance for each the plurality of skills and tasks using the remote working criteria.

12. The machine learning method of claim 10, further comprising:
receiving, via the at least one computing device, a remote work result for the position subsequent to fulfilment of the position; and
retraining, via the at least one computing device, the machine learning model based on the remote work result.

13. A non-transitory computer-readable medium embodying a program that, when executed by at least one computing device, causes the at least one computing device to:
receive data describing at least one aspect of a position for an entity;
generate metadata for the position based on the data describing the at least one aspect of the position, the metadata comprising a plurality of skills and tasks associated with the position;
identify a plurality of task locations for the entity;
determine a distribution of capacity across the plurality of task locations based on entity data corresponding to the entity;
generate a plurality of physical proximity scores for each of the plurality of skills and tasks based on the metadata for the position, the distribution of capacity, and the plurality of task locations; and
generate a remote work score for the position based on the plurality of physical proximity scores.

14. The non-transitory computer-readable medium of claim 13, wherein the program further causes the at least one computing device to generate the remote work score by combining the plurality of physical proximity scores for each of the plurality of skills and tasks according to a predetermined weighting.

15. The non-transitory computer-readable medium of claim 14, wherein the program further causes the at least one computing device to compute the predetermined weighting for combining the plurality of physical proximity scores based on the metadata.

16. The non-transitory computer-readable medium of claim 13, wherein the program further causes the at least one computing device to generate the remote work score via a trained machine learning model.

17. The non-transitory computer-readable medium of claim 16, wherein the program further causes the at least one computing device to generate the trained machine learning model by:
generating an initial machine learning model;
training, with a training dataset, the initial machine learning model to generate one or more experimental remote work predictions, wherein the training dataset comprises historical entity data associated with the position and one or more known remote work outcomes associated with the historical entity data;
determining an error of the initial machine learning model by comparing the one or more experimental remote work predictions to the one or more known remote work outcomes; and
generating a secondary machine learning model by adjusting the initial machine learning model based on the error, wherein the trained machine learning model is the secondary machine learning model.

18. The non-transitory computer-readable medium of claim 17, wherein:
the initial machine learning model comprises a plurality of parameters and a first set of weight values that are applied to each of the plurality of parameters, wherein:
the plurality of parameters are based on the plurality of physical proximity scores; and
the first set of weight values determines a level of contribution of each of the plurality of parameters to the remote work score; and
the program further causes the at least one computing device to generate the secondary machine learning model by:
determining at least one of the plurality of parameters that most contributed to the error;
adjusting one or more weight values of the first set of weight values that are associated with the at least one the plurality of parameters to generate a secondary set of weight values; and
generating the secondary machine learning model based on the plurality of parameters and the secondary set of weight values.

19. The non-transitory computer-readable medium of claim 13, wherein the program further causes the at least one computing device to generate a report comprising the remote work score.

20. The non-transitory computer-readable medium of claim 19, wherein:
the program further causes the at least one computing device to determine at least one physical proximity score from the plurality of physical proximity scores that most positively contributed to the remote work score; and
the report further comprises the at least one physical proximity score that most positively contributed to the remote work score.
